(19) United States
(12) Patent Application Publication
(10) Pub. No.: US 2003/0092189 A1
(43) Pub. Date: May 15, 2003

(54) Method and device for determining chlorine dioxide in aqueous solutions

(76) Inventors: Lydia K. Johnson, Denton, MD (US); Vinay D. Ghanekar, Wilmington, DE (US)

Correspondence Address: J.W. Gipple, GIPPLE & HALE, P. O. Box 40513, Washington, DC, 20016, US

(21) Appl. No.: 09/978,223

(22) Filed: Oct. 16, 2001

(51) Int. Cl. G01N 31/22

(52) U.S. Cl. 436/125; 436/124; 436/127; 436/164; 436/169; 422/56

(57) ABSTRACT

A test method and device are described for quantitatively determining the presence and concentration of chlorine dioxide in aqueous solution, which may contain chlorine. Contacting the aqueous solution containing chlorine dioxide with a test strip in accordance with the invention produces a color change in proportion to the concentration of the chlorine dioxide. The invention has particular utility in determining the presence of chlorine dioxide in water containing chlorine such as municipal water.

### FIELD OF THE INVENTION

The present invention is directed to a device and method for determining the concentration of chlorine dioxide in aqueous solutions, and, in particular, in aqueous solutions containing a chlorine interference.

### BACKGROUND OF THE INVENTION

Chlorine dioxide was suggested as a sterilizing agent for water in 1900 but it was not used on a plant scale until 1944. It is used in water treatment to control phenolic tastes and odors. It has been also found successful in controlling a variety of tastes due to both algae and decaying vegetation and is also used extensively as a bleaching agent in the pulp and paper industry, as a disinfectant in the food industry for fruit and vegetable washing, flume water disinfecting, meat and poultry disinfection, food process equipment sanitizing and odor control. It is a more effective disinfectant for water at higher pH (>8) and for waters containing high levels of ammonia or phenolic compounds. Chlorine dioxide is an effective disinfectant in applications where the removal of biofilm is required. Chlorine dioxide dissolves in water rather than hydrolyzing and can penetrate a biofilm layer, loosen the biopolymer matrix, slough the biofilm and effectively kill the exposed microorganism. Whereas, chlorine and bromine are not capable of penetrating biofilm except at high concentrations.

Many of these applications of chlorine dioxide require verification that the chlorine dioxide has been removed from the water before the potable water or food product or beverage can be used for human consumption. Since municipal water supplies commonly use chlorine as a disinfectant and a residual level of chlorine remains in the water, it is necessary that the chlorine dioxide test be free of interference from chlorine. As the number of chlorine dioxide applications increases, the development of a reliable, simple, and rapid test is necessary.

Many methods for testing chlorine dioxide have been described in the literature and used by industry. They include the iodometric, amperometric, and colorimetric methods with ortho-tolidine-oxalic acid, tyrosine, H-acid and the DPD method. They suffer from varying degrees of interferences and are generally complex and not easily used for testing in the field.

The present invention provides a test strip device that is quick and easy to use in field applications for testing chlorine dioxide especially in the presence of chlorine.

### SUMMARY OF THE INVENTION

In accordance with the present invention, a composition, method and device are provided for determining the concentration of chlorine dioxide in aqueous solutions which may contain chlorine. The device of the invention includes an absorbent matrix, including but not limited to cellulose based paper, glass fiber or polyester onto which the indicator reagent composition is absorbed and then dried to form a test strip. The composition of the invention is capable of reacting with chlorine dioxide in aqueous solution at concentrations from 0-10 ppm to give a color change indicative of the concentration of chlorine dioxide present without interference from chlorine present in the solution.

The method of the invention comprises contacting a test solution with the composition of the invention, which may be a dried deposit on an absorbent matrix, observing the resultant color change and comparing the resultant color with a standard color index of colors at specific chlorine dioxide concentrations to quantitatively determine the chlorine dioxide concentration.

### DETAILED DESCRIPTION OF THE INVENTION

The composition, method and device of the present invention for measuring the chlorine dioxide concentration in aqueous solutions includes an indicator reagent composition deposited on a carrier matrix of suitable bibulous material such as a cellulosic matrix and capable of reacting with chlorine dioxide to give a color change in proportion to the concentration of chlorine dioxide present over a range of 0-10 ppm. At the same time, the amino acid, amine or salts of ammonia masks the chlorine interference with a minimal interaction with the chlorine dioxide itself.

The indicator composition of the invention comprises:

a redox indicator that gives a color change on reaction with chlorine dioxide, such as heterocyclic azine and benzidine type indicators.

a buffer for maintaining the composition pH in the range 5-7, such as an alkali metal phosphate

0.1-2% of a surfactant

0.1-2% of a polymer

0.05-0.2% of any amines, salts of ammonia or amino acids or other amphoteric dipolor ion or zwitterion to prevent chlorine interference

suitable carrier matrix of bibulous material either natural or synthetic such as absorbent paper, glass fiber or polyester.

Typical redox indicators for the invention are compounds of the formula:

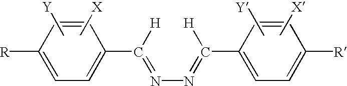

where R and R′ are selected from the group consisting of hydroxy and amino groups and X,X′, Y and Y′ are selected from the group consisting of hydrogen, hydroxy, methyl, methoxy, ethyl and ethoxy groups.

Masking of interfering chlorine in the aqueous test solution is achieved, in accordance with the invention, by inclusion of carefully controlled concentrations of amines, salts of ammonia or amphoteric components that provide dipolar ions or zwitterions that prevent interference with chromogenic indicator changes by chlorine present in the test solution. Typically, such components are amino acids such as glycine, alanine, leucine, proline, and histidine; and are used in concentrations of 0.05 to 0.2%.

The following examples are illustrative, but not limiting, of the present invention.

Test strips were prepared by dipping absorbent paper in the indicated solution and then drying.

Examples 1-8 illustrate various amino acids used as chlorine masking agents.

Dipping Solution:

| | |
|---|---|
| 0.25 M phosphate buffer with 0.2% indicated amino acid | 32.4 ml |
| 1% CPB (cetylpyridium bromide) | 24.3 ml |
| 5% PVP (polyvinyl pyrrolidone) | 16.2 ml |
| 0.1% syringaldazine in ethanol | 27.0 ml |

| | Example 1 | | | |
|---|---|---|---|---|
| | No masking | Example 2 | Example 3 | Example 4 |
| | agent | Glycine | Alanine | Leucine |
| | Test strip | Test strip | Test strip | Test strip |
| Concentration | color | color | color | color |
| 0 ppm Cl O₂ | Yellow | Yellow | Yellow | Yellow |
| 1 ppm Cl O₂ | Trace pink | Trace pink | Trace pink | Trace pink |
| 3 ppm Cl O₂ | Lt. Pink | Lt. Pink | Lt. Pink | Lt Pink |
| 5 ppm Cl O₂ | Pink | Pink | Pink | Pink |
| 10 ppm Cl O₂ | Magenta | Magenta | Magenta | Magenta |
| 1.5 ppm Cl₂ | Pink | Yellow | Yellow | Yellow |

| | Example 5 | Example 6 | Example 7 | Example 8 |
|---|---|---|---|---|
| | Proline | Histidine | Ethanolamine | Ammonium |
| | Test strip | Test strip | Test strip | chloride |
| Concentration | color | color | color | Test strip color |
| 0 ppm Cl O₂ | Yellow | Yellow | Yellow | Yellow |
| 1 ppm Cl O₂ | Trace pink | Trace pink | Trace pink | Trace pink |
| 3 ppm Cl O₂ | Lt Pink | Lt. Pink | Lt. Pink | Lt. Pink |
| 5 ppm Cl O₂ | Pink | Pink | Pink | Pink |
| 10 ppm Cl O₂ | Magenta | Magenta | Magenta | Magenta |
| 1.5 ppm Cl O₂ | Yellow | Yellow | Yellow | Yellow |

Example 9 illustrates alternative surfactant and polymer dipping solution:

| | |
|---|---|
| 0.25 M Phosphate buffer with 0.6% Glycine | 32.4 ml |
| 4% KLUCEL (Hydroxypropyl Cellulose) polymer | 16.2 ml |
| 0.6% Benzalkonium chloride (surfactant) | 24.3 ml |
| 0.1% syringaldazine in ethanol | 27.0 ml |

| ppm Cl O₂ | Test Strip Color |
|---|---|
| 0 | Lt. Yellow |
| 1 | Trace Pink |
| 3 | Lt. Lavender |
| 5 | Lavender |
| 10 | Purple |
| 1.5 ppm Cl₂ | Lt. Yellow |

While a preferred embodiment of the present invention has been herein described, it will be understood that other embodiments and alternatives are considered to fall within the scope of the invention as defined in the claims. It will, for example, be appreciated by those of ordinary skill in the art that various colorgraphic and chromagraphic procedures can be employed to quantify color changes in the test device and composition. It will also be understood that various alternative buffers, polymers, surfactants and indicators can be employed without departing from the intended scope of the invention.

What is claimed:

1. A method for determining the concentration of chlorine dioxide in aqueous solution containing chlorine, the method comprising:
A. Contacting an aqueous test solution containing chlorine dioxide with a reagent composition comprising:
a. A chromogenic indicator capable of reacting with chlorine dioxide present in said aqueous test solution to give a color response proportional to the concentration of said chlorine dioxide;
b. A buffer to maintain the test solution and composition at a pH of 5 to 7;
c. 0.1 to 2% surfactant;
d. 0.1 to 2% of a stabilizing polymer; and
e. 0.05 to 0.2% of an amphoteric component that provides dipolar ions or zwitterions or simple amine or a salt of ammonia in said aqueous solution to prevent interference by chlorine in the reaction of said chromogenic indicator with said chlorine dioxide;
B. Comparing said color response obtained to color responses obtained from known standardized aqueous solutions containing chlorine dioxide and translating such comparisions to the concentration of chlorine dioxide in the test solution.

2. The method of claim 1 wherein said chromogenic indicator is a redox indicator.

3. The method of claim 2 wherein said indicator is a heterocyclic azine or benzidine.

4. The method of claim 1 wherein said amphoteric component is an amino acid.

5. The method of claim 4 wherein said amino acid is one or more components selected from glycine, alanine, leucine, proline and histidine.

6. The method of claim 1 wherein the reagent composition is incorporated onto a fluid absorbent matrix material and the matrix is contacted with the test solution sample.

7. The method of claim 6 wherein the fluid absorbent matrix material is a cellulose based paper, glass fiber or polyester material.

8. The method of claim 3 wherein said indicator is syringaldazine.

9. A method for determining the concentration of chlorine dioxide in aqueous solution comprising:
A. contacting a test solution sample with a reagent composition deposited on an absorbent matrix material comprising a) a chromogenic indicator material selected from the group consisting of (1) a compound having the formula 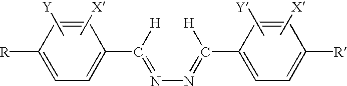
where R and R′ are selected from the group consisting of hydroxy and amino groups and X,X′, Y and Y′ are selected from the group consisting of hydrogen, hydroxy, methyl, methoxy, ethyl and ethoxy groups; b) a buffer to maintain the test composition and test solution sample in a pH range of about from 5 to 7; c) 0.05 to 0.2% of an amphoteric amino acid or amine or a salt of ammonia that prevents chlorine in the test solution from interfering with color response by said chromogenic indicator material. d) 0.1 to 2% surfactant and; e) 0.1 to 2% of a stabilizing polymer, and
B. comparing the color response obtained to color responses from standardized solutions of chlorine dioxide and translating such comparison to the amount of chlorine dioxide in the test solution.

10. A test device for the determination of chlorine dioxide in aqueous solutions comprising a matrix material incorporated with the dried residue of a test composition comprising:
A. A chromogenic indicator capable of reacting with chlorine dioxide to give a color change;
B. A buffer to maintain the test solution and composition at pH of 5 to 7;
C. 0.05 to 0.2% of an amphoteric component or amine or a salt of ammonia that prevents interference by chlorine in the solution with color response by said chromogenic indicators.
D. 0.1 to 2.0% surfactant E. 0.1 to 2.0% of a stabilizing polymer

11. The test device of claim 10 wherein said chromogenic indicator is a heterocyclic azine or benzidine.

12. The test device of claim 11 wherein said chromogenic indicator is syringaldazine.

13. The test device of claim 10 wherein said amphoteric component is an amino acid.

14. The test device of claim 10 wherein said matrix material is absorbent cellulosic paper.

15. The test device of claim 13 wherein said amino acid is one or more components selected from glycine, alanine, leucine, proline and histidine.
